(19) United States
(12) Patent Application Publication
(10) Pub. No.: US 2021/0056634 A1
(43) Pub. Date: Feb. 25, 2021

(54) METHODS AND SYSTEMS FOR FACILITATING MODELING OF A FINANCIAL INSTRUMENT BASED ON A PHYSICAL MODEL

(71) Applicant: Royce Wells, Lakeland, TN (US)

(72) Inventor: Royce Wells, Lakeland, TN (US)

(21) Appl. No.: 16/547,946

(22) Filed: Aug. 22, 2019

Related U.S. Application Data
(60) Provisional application No. 62/800,984, filed on Feb. 4, 2019.

(51) Int. Cl. G06Q 40/06

(52) U.S. Cl. CPC G06Q 40/06; G06N 20/00

(57) ABSTRACT

A method of modeling a financial instrument may include a step of receiving, using a communication device, at least one parameter associated with the financial instrument. Further, the method may include a step of analyzing, using a processing device, the at least one parameter. Further, the method may include a step of identifying, using the processing device, the physical model based on the analyzing. Further, the method may include a step of generating, using the processing device, the financial instrument model based on the identifying and the analyzing. Further, the method may include a step of receiving, using the communication device, a request from a user device. Further, the method may include a step of generating, using the processing device, a response based on the request and the financial instrument model. Further, the method may include a step of transmitting, using the communication device, the response to the user device.

The current application claims a priority to the U.S. provisional patent application Ser. No. 62/800,984 filed on Feb. 4, 2019.

### FIELD OF THE INVENTION

Generally, the present disclosure relates to the field of data processing. More specifically, the present disclosure relates to methods and systems for facilitating modeling of a financial instrument based on a physical model.

### BACKGROUND OF THE INVENTION

Modeling of financial instruments (such as equity, currency, foreign exchange, shares, mutual funds, etc.) is a task of building an abstract representation of a real-world financial situation. Such models are designed to represent the performance of a financial asset or portfolio of a business, project, or any other investment. Further, these models may be used for decision making and performing financial analysis. Further, in an instance, individuals/organizations may use such models to forecast a business' financial performance. Therefore, allowing them to make decisions about raising capital, making acquisitions, selling assets or business units, etc.

Earlier approaches for the modeling of financial instruments are usually based on the prediction of future data by using previous historical data. Such approaches for prediction. may not be highly reliable as the future data is estimated based on an assumption that historical data will hold true for future situations as well.

Further, no approaches for modeling of financial instruments are based on the real-world physical scenarios.

Therefore, there is a need for improved methods, systems, apparatuses and devices for facilitating modeling a financial instrument based on a physical model that may overcome one or more of the above-mentioned problems and/or limitations.

### BRIEF SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of modeling a financial instrument based on a physical model, in accordance with some embodiments. Accordingly, the method may include a step of receiving, using a communication device, at least one parameter associated with the financial instrument. Further, the method may include a step of analyzing, using a processing device, the at least one parameter. Further, the method may include a step of identifying, using the processing device, the physical model based on analyzing. Further, the method may include a step of generating, using the processing device, the financial instrument model based on identifying and analyzing. Further, die method may include a step of receiving, using the communication device, a request from a user device. Further, the method may include a step of generating, using the processing device, a response based on the request and the financial instrument model. Further, the method may include a step of transmitting, using the communication device, die response to the user device.

Further disclosed herein is a system for facilitating modeling of a financial instrument based on a physical model, in accordance with some embodiments. Accordingly, the system may include a communication device configured for receiving at least one parameter associated with the financial instrument. Further, the communication device may be configured for receiving a request from a user device and transmitting a response to the user device. Further, the system may include a processing device configured for analyzing the at least one parameter. Further, the processing device may be configured for identifying the physical model based on analyzing. Further, the processing device may be configured for generating the financial instrument model based on identifying and analyzing. Further, the processing device may be configured for generating the response based on the request and the financial instrument model.

Both the foregoing summary and the following detailed description provide examples and are explanatory only. Accordingly, the foregoing summary and the following, detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a flowchart of a method of modeling a financial instrument based on a physical model in accordance with some embodiments.

FIG. 3 is a block diagram of a system to facilitate modeling of a financial instrument based on a physical model in accordance with some embodiments.

FIG. 4 is a block diagram of a computing device for implementing the methods disclosed herein, in accordance with some embodiments.

### DETAILED DESCRIPTION OF THE. INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein. of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. indeed, the steps in such processes or methods generally may be carried out in various different sequences and orders while still falling within the scope of the present disclosure. Accordingly, it is intended that the scope of patent protection is to be defined by the issued claim.(s) rather than the description, set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of modeling a financial instrument based on a. physical model, embodiments of the present disclosure are not limited to use only in this context.

In general, the method disclosed herein may be performed by one or more computing devices. For example, in some embodiments, the method may be performed by a. server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a. video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data. compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In i2eneral, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited. to, location, time, identity of a user associated with a device (e.g., the server computer, a client device etc.) corresponding to the performance of the one or more steps, environmental variables (e.g. temperature, humidity, pressure, wind speed. lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in sonic embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to he transmitted to the server computer. Accordingly, one or more steps of the method operating on the sensitive data and/or a derivative thereof may be performed at the client device.

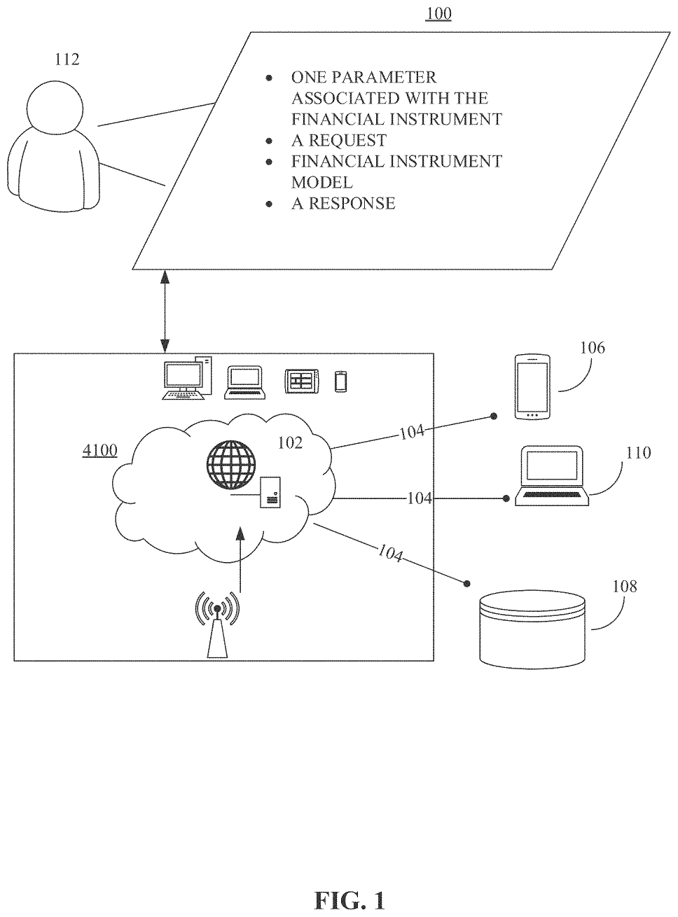

FIG. 1 is an illustration of an online platform 100 consistent with various embodiments of the present disclosure. By way of non-limiting example, the online platform 100 to facilitate modeling of a financial instrument based on a physical model may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108 over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform.

A user 116, such as the one or more relevant parties, may access online platform 100 through a web-based software application or browser. The web-based software application may be embodied as, for example, but not be limited to, a website, a web application, a desktop application, and a mobile application compatible with a computing device 4100.

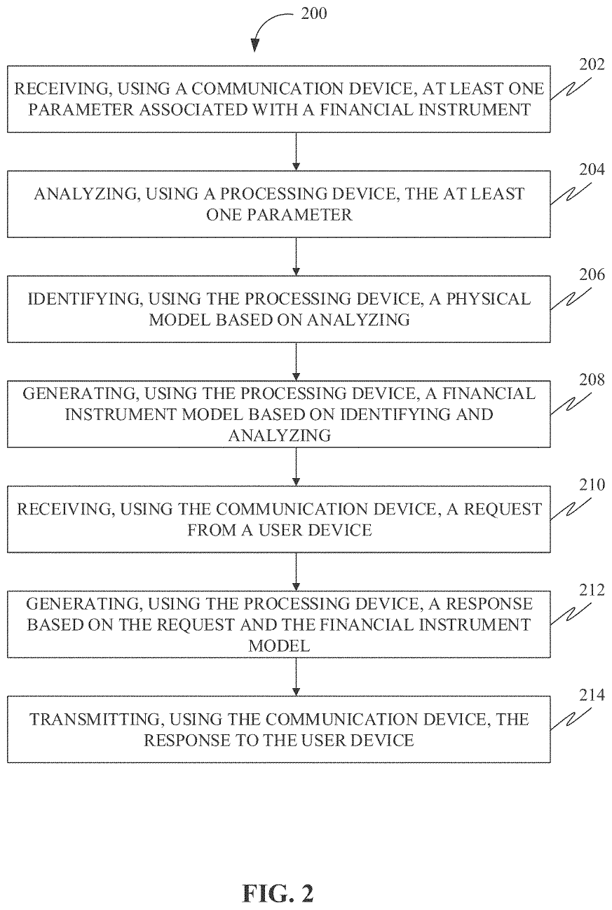

FIG. 2 is a flowchart of a method 200 of modeling a financial instrument based on a physical model in accordance with some embodiments. Further, the modeling mar include at least one of explaining, quantifying and forecasting of an output data associated with the financial instrument. Further, the modeling may include determining, a trajectory of at least one parameter associated with the financial instrument. Further, the at least one parameter may include a plurality of data values associated with the financial instrument. Further, the plurality of data values may be associated with a plurality of physical objects. Further, in an embodiment, the financial instrument may include at least one of an equity, a mutual fund, a. currency and a cryptocurrency, a bond and a commodity.

According to some embodiments, the physical model may include at least one law governing at least one physical object. Further, the at least one law may include a law of physics, a law of probability, a law of statistics, and so on. Further, the physical model may include at least one physical object and at least one physical variable corresponding to the at least one physical object and the at least one law governing the behavior of the at least one physical object.

Further, the physical model may include the at least one law governing the interaction between a plurality of physical models. Further, in an embodiment, the physical model may include a real-world physical model. Further, the real-world physical model may include at least one of a physics model, a meteorological model, a quantum mechanics model, a statistics model, and a probability model.

At 202, the method 200 may include a step of receiving, using a communication device, the at least one parameter associated with the financial instrument.

At 204, the method 200 may include a step of analyzing, using a processing device, the at least one parameter.

At 206, the method 200 may include a step of identifying, using the processing device, the physical model based on the analyzing.

At 208, the method 200 may include a step of generating, using the processing device, the financial instrument model based on identifying and analyzing. Further, in an embodiment, the financial instrument model may include associating, using the processing device, the at least one parameter to at least one of the at least one physical object, the at least one physical variable and the at least one law. Further, the at least one parameter may include the plurality of data values corresponding to a property of the financial instrument. Further, the property of the financial instrument may include a direction or a trend of the financial instrument. Further, the plurality of data values may be associated with a plurality of physical objects included in the physical model. Further, at least one metric associated with the plurality of data values may be associated with the at least one law. Further, the at least one metric may include data points associated with the financial model.

Further, the plurality of data values corresponding to the property of the financial instrument may be associated with the at least one law governing the behavior of the at least one physical object included in the physical model. Further, the at least one metric associated with the plurality of data values may be associated with the at least one physical variable corresponding to the at least one physical object. Further, the plurality of data values corresponding to the property of the financial instrument may be associated with the at least one physical variable corresponding to the at least one physical object. Further, the at least one metric associated with the plurality of data values may be associated with the at least one physical object included in the physical model.

At 210, the method 200 may include a step of receiving, using the communication device, a request from a user device (such as the mobile devices 106 and the electronic devices 110). Further, according to some embodiments, the request associated with the at least one parameter based on a financial data may be received from the user device such as the mobile devices 106 and the electronic devices 110). Further, the request associated with the at least one parameter may include a future performance data associated with the financial data. Further, the financial instrument model may predict the future performance data associated with the financial data based on the physical model. Alternatively, the request may be received from a third party database (such as the database 108). Further, the request may include an indicator associated with the at least one parameter based on the financial data. Further, the indicator include a change in the behavior of the financial instrument model. Further, the financial instrument model may be generated based on the analysis of the financial data.

At 212, the method 200 may include a step of generating, using the processing device, a response based on the request and the financial instrument model. Further, according to some embodiments, the response based on the request and the financial instrument model may include a predicted data based on the physical model. Further, the predicted data may include a trajectory of the at least one parameter associated with the financial data based on the request.

At 214, the method. 200 may include a step of transmitting, using the communication device, the response to the user device (such as the mobile device 106 and the electronic devices 110).

Further, according to some embodiments, the financial instrument model may include at least one or more physical variables associated with the financial instruments. Further, the one or more physical variables associated with the financial instruments may include at least one of a speed, a direction, and an extreme of each of the financial instruments. Further, the at least one or more physical enables may be determined by using at least one or more parameters associated with a plurality of input data. Further, in an instance, the at least one or more parameters may include a one standard deviation hands or a Pi standard deviation band. Further, in an instance, the plurality of input data may include a moving average associated with the financial instrument. Further, the at least one of the speed and the direction of each of the financial instruments may be determined by using ten one standard deviation hands of varying sample length based on the plurality of input data. Further, the at least one of the extremes associated with the financial instruments may be determined by using ten Pi standard deviation band of varying sample length based on the plurality of input data. Further, in an instance, the financial instrument model may include the law of probability, Further, the at least one physical variable associated with the financial instruments change whenever the financial instruments exceed a specific probability. Further, the at least one physical variable associated with the financial instruments may include an acceleration associated with the financial instruments.

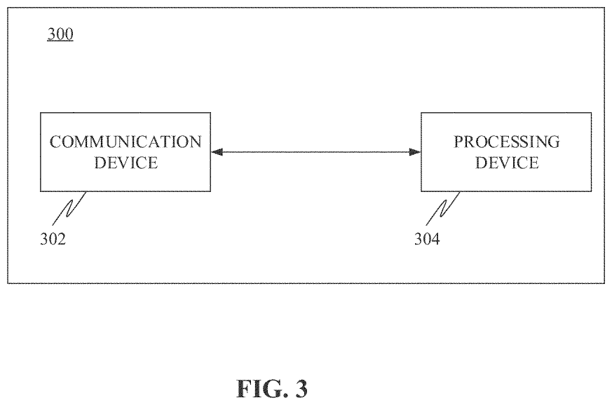

FIG. 3 is a block diagram of a system 300 to facilitate modeling of a financial instrument based on a physical model in accordance with some embodiments. Further, the system 300 may include a communication device 302 and a processing device 304. Further, the modeling may include at least one of explaining, quantifying and forecasting of an output data associated with the financial instrument. Further, the modeling may include determining a trajectory of at least one parameter associated with the financial instrument.

Further, the at least one parameter may include a plurality of data values associated with the financial instrument. Further, the plurality of data values be associated with a plurality of physical objects. Further, in an embodiment, the financial instrument may include at least one of an equity, a mutual fund, a currency and a cryptocurrency, a bond and a commodity.

Further, according to some embodiments, the physical model may include at least one law governing at least one physical object. Further, the at least one law may include a law of physics, a law of probability, a law of statistics, and so on. Further, the physical model may include the at least one law governing the interaction between a plurality of physical models. Further, in an embodiment, the physical model may include a real-world physical model. Further, the real-world. physical model may include at least one of a physics model, a meteorological model, a quantum mechanics model, a statistics model, and a probability model. Further, the physical model may include at least one physical object and at least one physical variable corresponding to the at least one physical object and the at least one law governing the behavior of the at least one physical object.

Further, according to some embodiments, the system 300 may include a communication device 302 configured for receiving the at least one parameter associated with the financial instrument.

Further, the communication device 302 may be configured for receiving a request from a user device (such as the mobile device 106 and the electronic devices 110). Further, in an instance, the request associated with the at least one parameter based on a financial data may be received from the user device (such as the mobile devices 106 and the electronic devices 110). Further, the request associated with the at least one parameter may include a future performance data associated with the financial data. Further, the financial instrument model may predict the future performance data associated with the financial data based on the physical model. Alternatively, the request may be received from a third party database (such as the database 108). Further, the request may include an indicator associated with the at least one parameter based on the financial data. Further, the indicator may include a change in the behavior ref the financial instrument model. Further, the financial instrument model may be generated based on the analysis of the financial data.

Further, the communication device 302 may be configured for transmitting a response to the user device (such as the mobile device 106 and the electronic devices 110). Further, the at least one parameter may include a plurality of data values corresponding to a property of the financial instrument. Further, the property of the financial instrument may include a direction or a trend of the financial instrument. Further, the plurality of data values may be associated with a plurality of physical objects included in the physical model. Further, at least one metric associated with the plurality of data values may be associated with the at least one law. Further, the at least one metric may include data points associated with the financial model. Further, the plurality of data values corresponding to the property of the financial instrument may be associated with the at least one law governing the behavior of the at least one physical object included in the physical model. Further, the at least one metric associated with the plurality of data values may be associated with the at least one physical variable corresponding to the at least one physical object.

According to some embodiments, the system 300 may include a processing device 304 configured for analyzing the at least one parameter.

Further, the processing device 304 may be configured for identifying the physical model based on analyzing.

Further, the processing device 304 may be configured for generating the financial instrument model based on identifying and analyzing. Further, in an instance, the financial instrument model may include at least one or more physical variables associated with the financial instruments. Further, the one or more physical variables associated with the financial instruments may include at least one of a speed, a direction, and an extreme of each of the financial instruments. Further, the at least one or more physical variables may be determined by using at least one or more parameters associated with a plurality of input data. Further, in an instance, the at least one or more parameters may include a one standard deviation bands or a Pi standard deviation band. Further, in an instance, the plurality of input data may include a moving average associated with the financial instrument. Further, the at least one of the speed and the direction of each of the financial instruments may be determined by using ten one standard deviation bands of varying sample length based on the plurality of input data. Further, the at least one of the extremes associated with the financial instruments may be determined by using ten Pi standard deviation band of varying sample length based on the plurality of input data. Further, in an embodiment, the financial instrument model may include the law of probability. Further, the at least one physical variable associated with the financial instruments may change whenever the financial instruments exceed a specific probability. Further, the at least one physical variable associated with the financial instruments may include an acceleration associated with the financial instruments.

Further, the processing device 304 may be configured for generating the response based on the request and the financial instrument model. Further, in an embodiment, the response based on the request and the financial instrument model may include a predicted data based on the physical model. Further, the predicted data may include a trajectory of the at least one parameter associated. with the financial data based on the request.

Further, in an embodiment, the financial instrument model may include associating, using the processing device 304, the at least one parameter to at least one of the at least one physical object, the at least one physical variable and the at least one law.

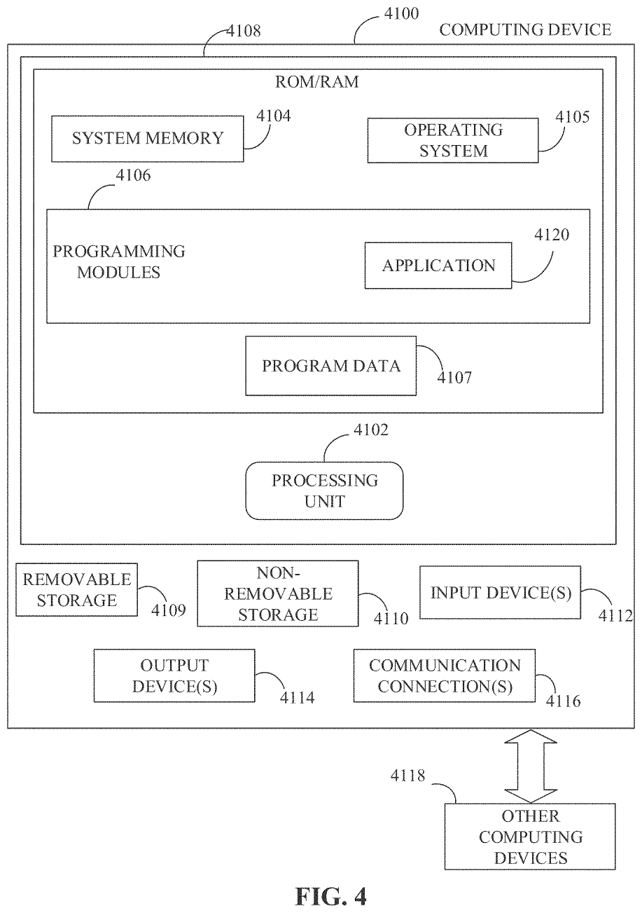

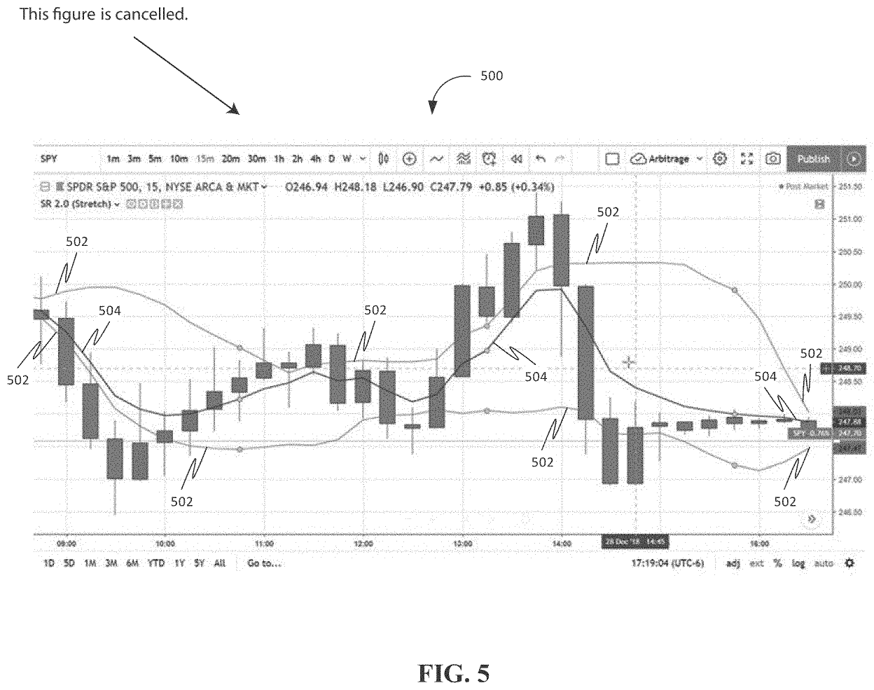

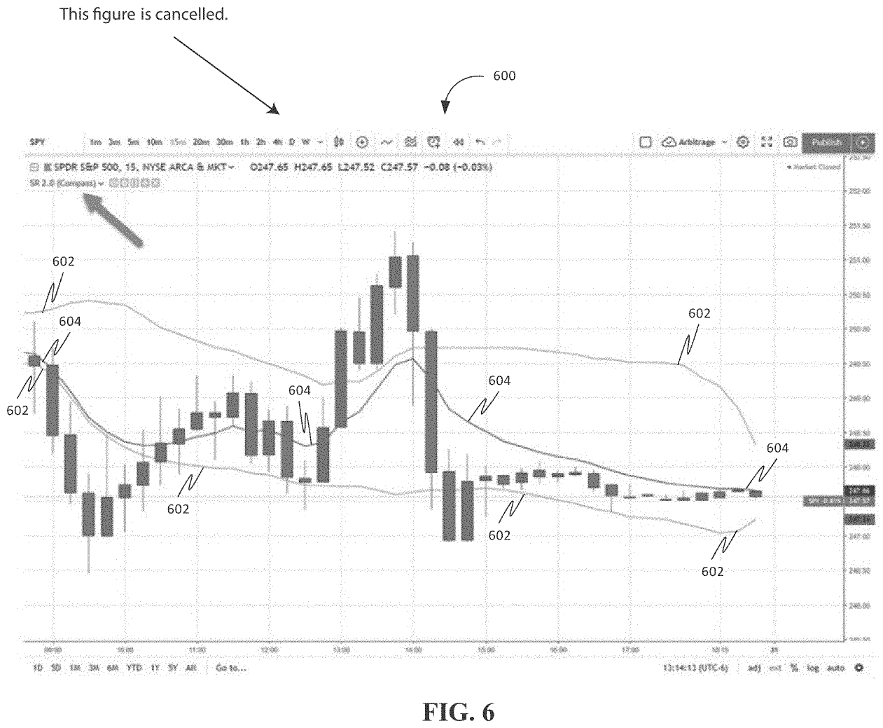

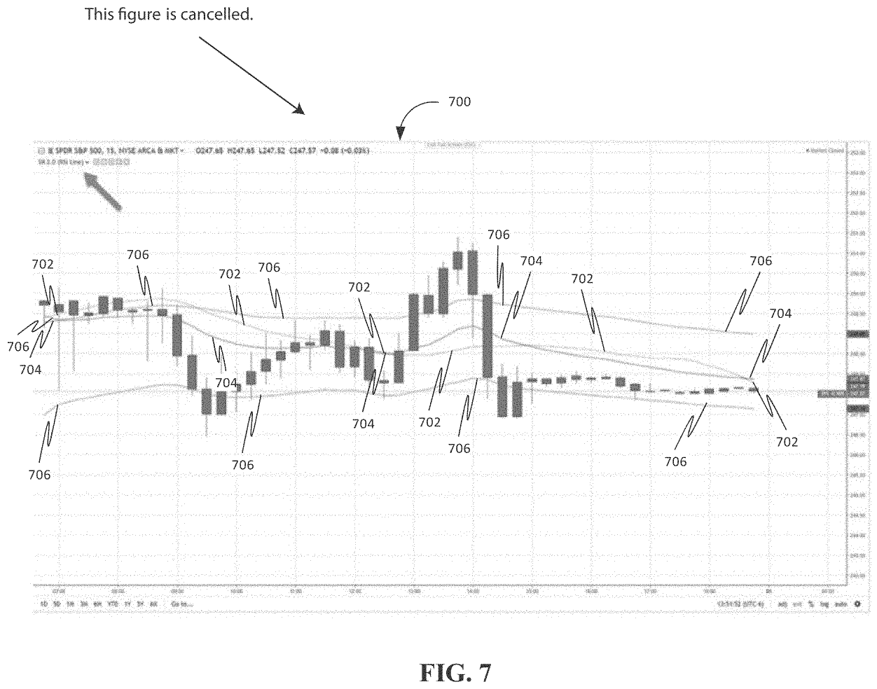

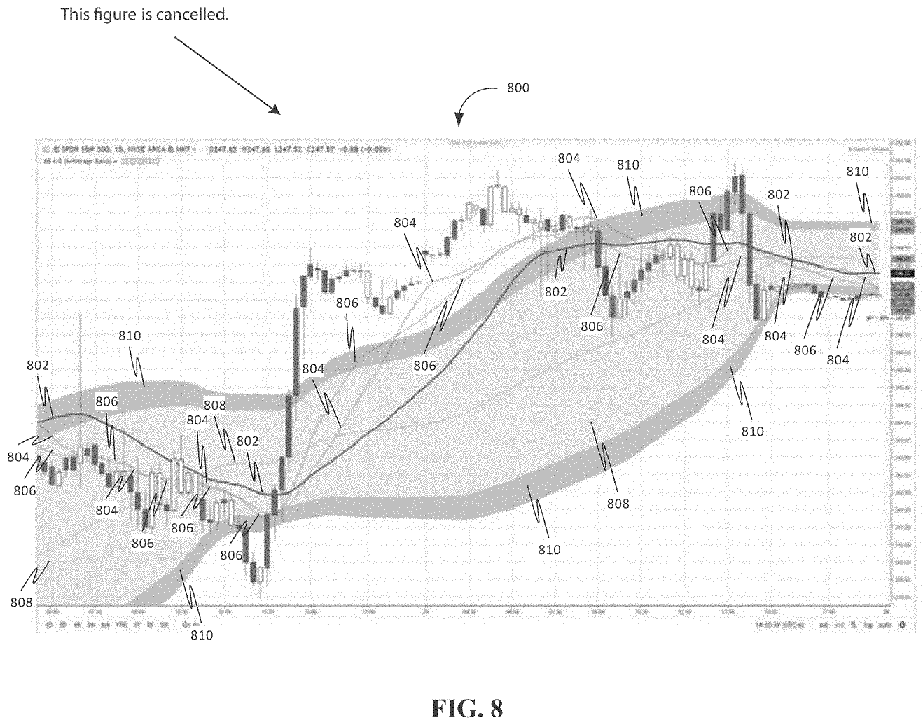

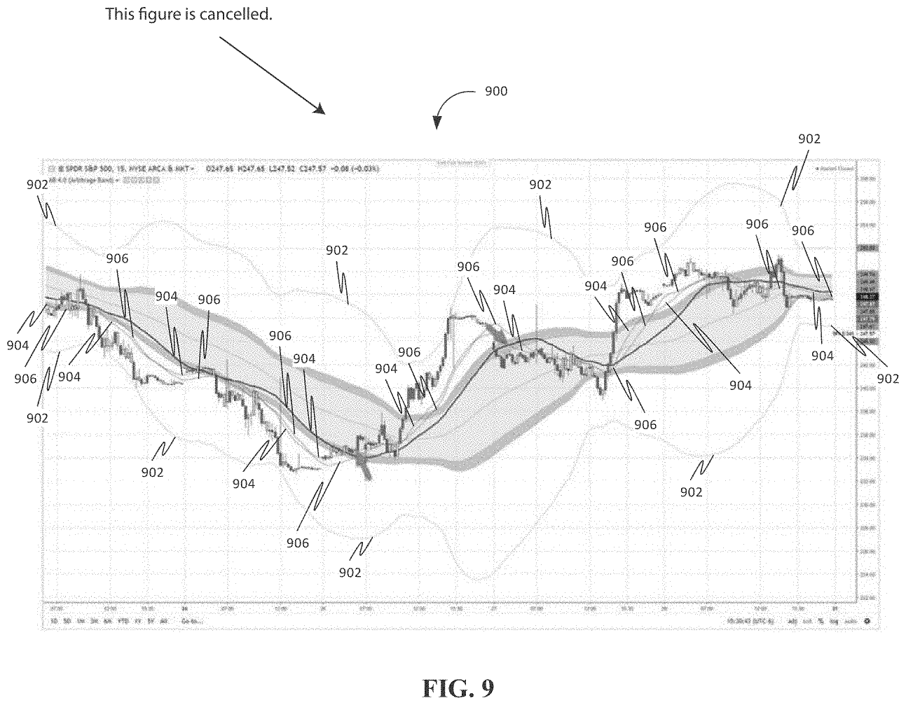

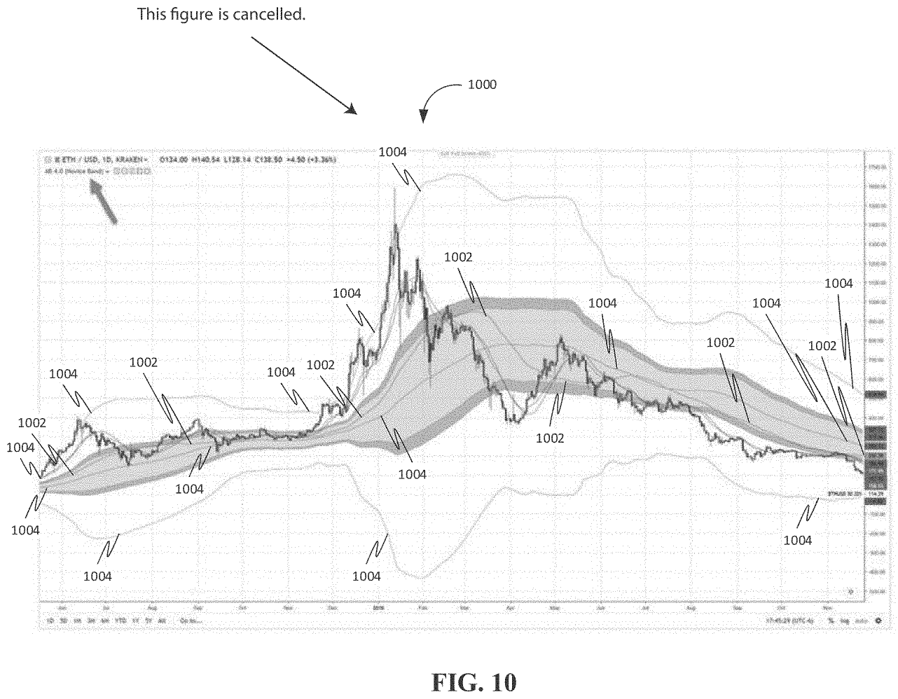

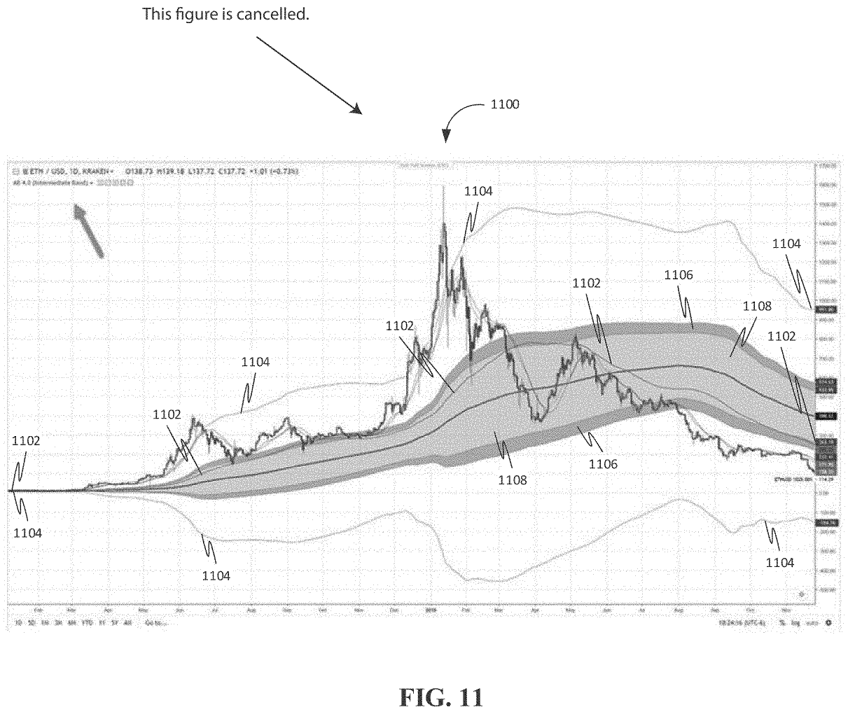

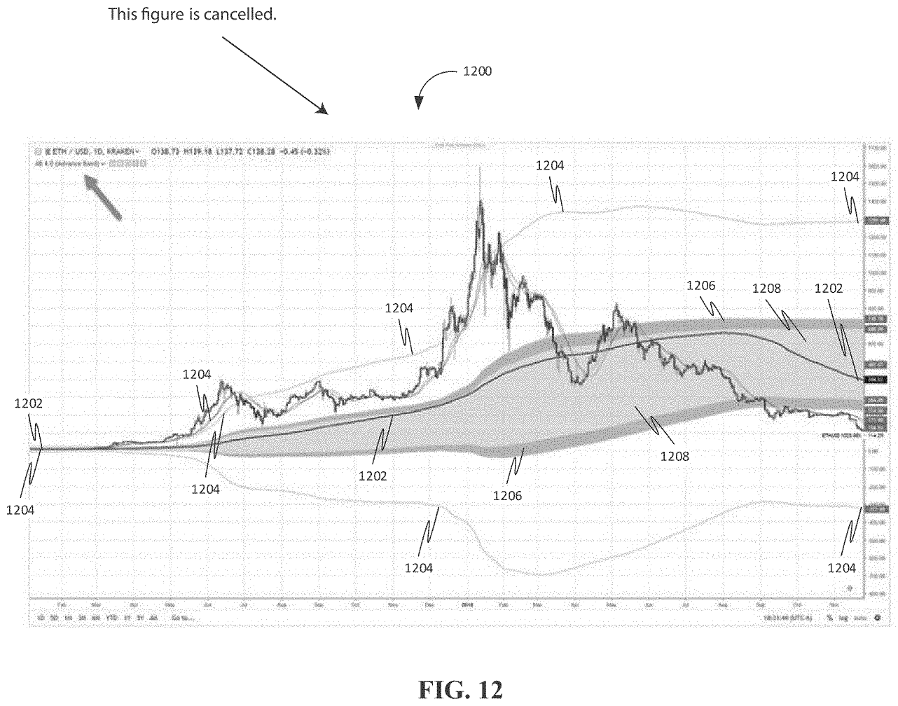

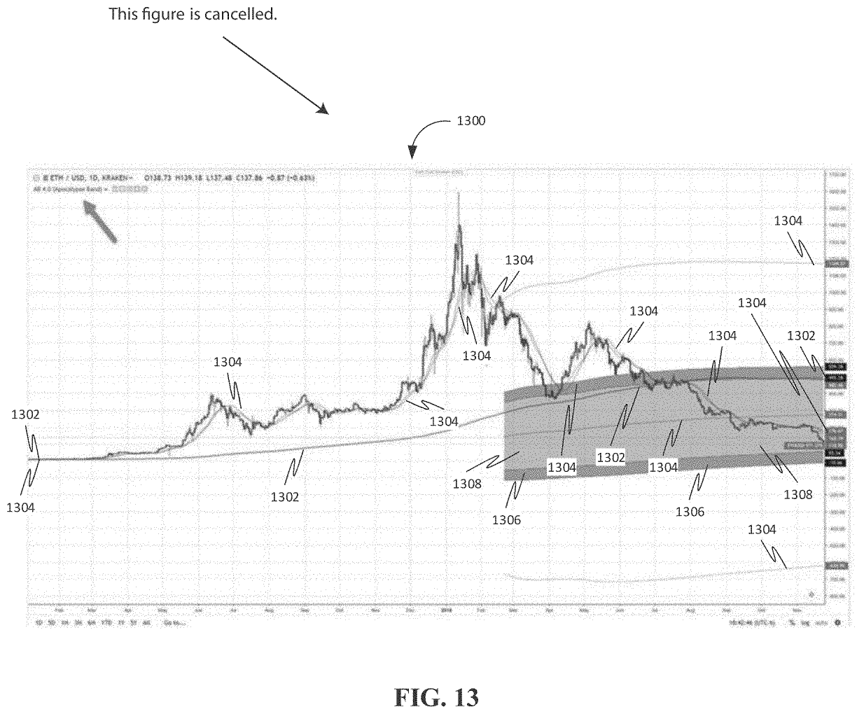

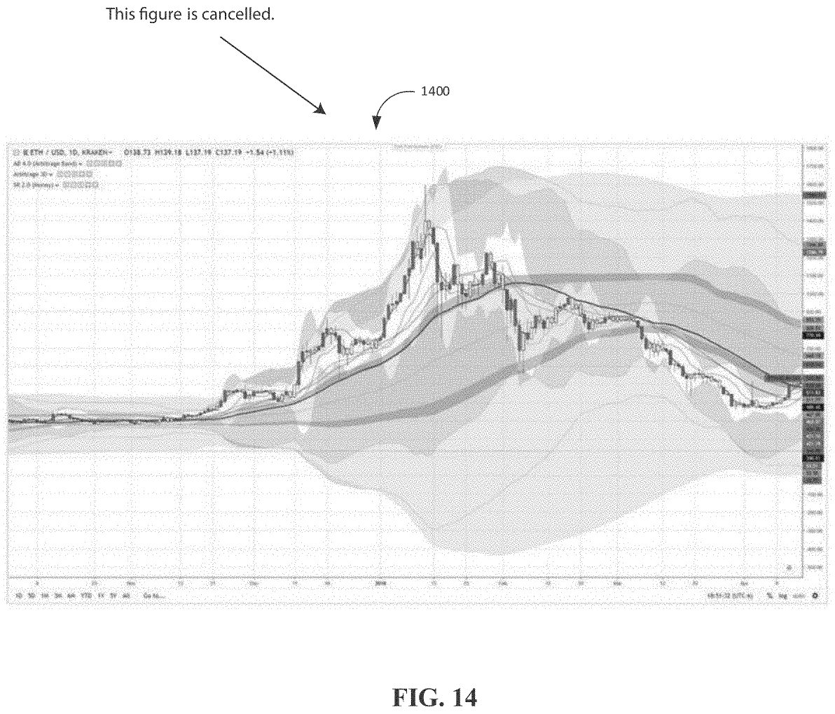

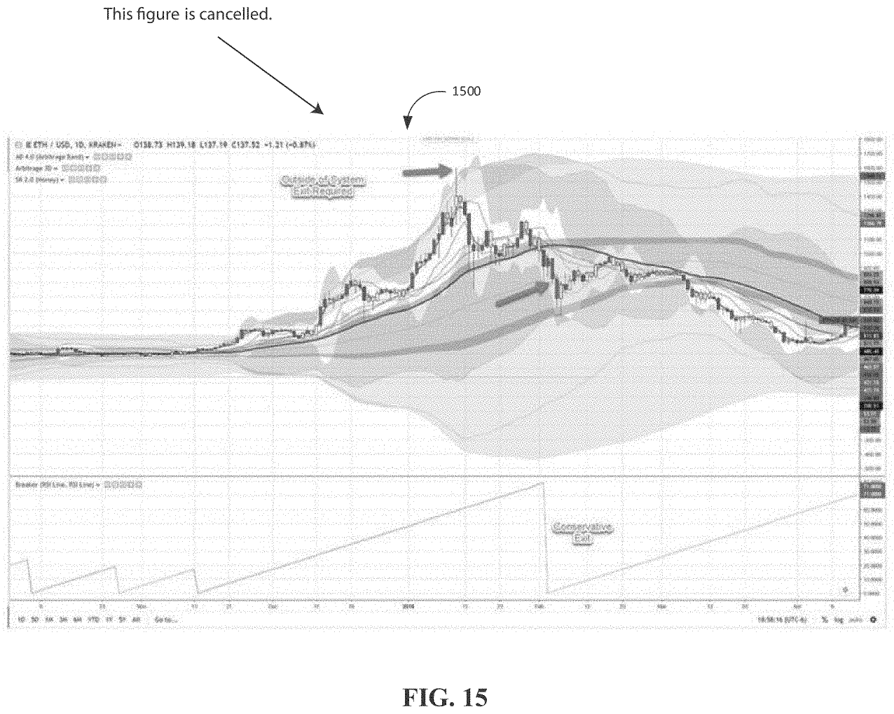

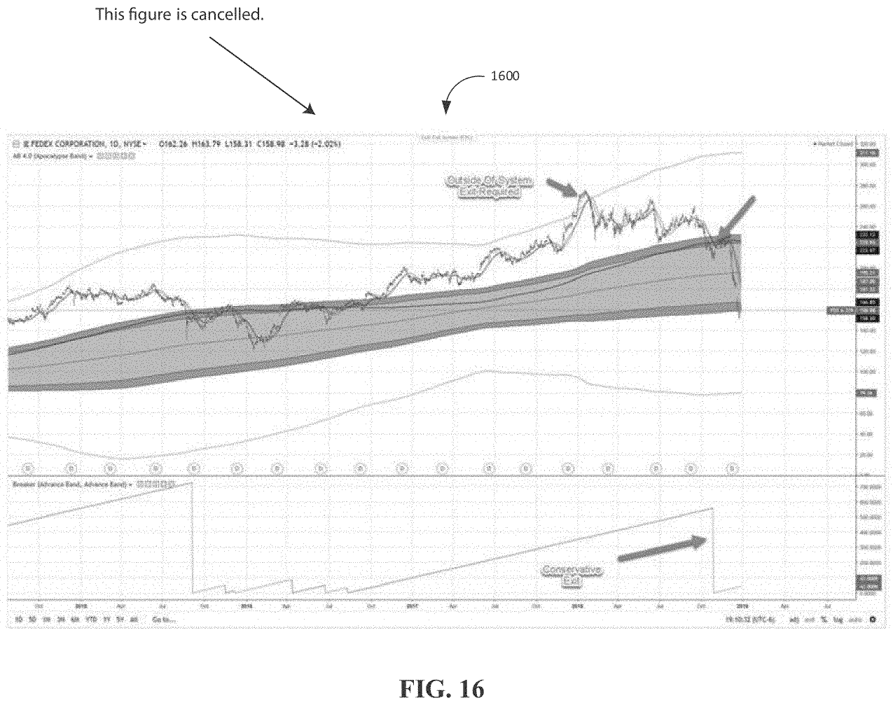

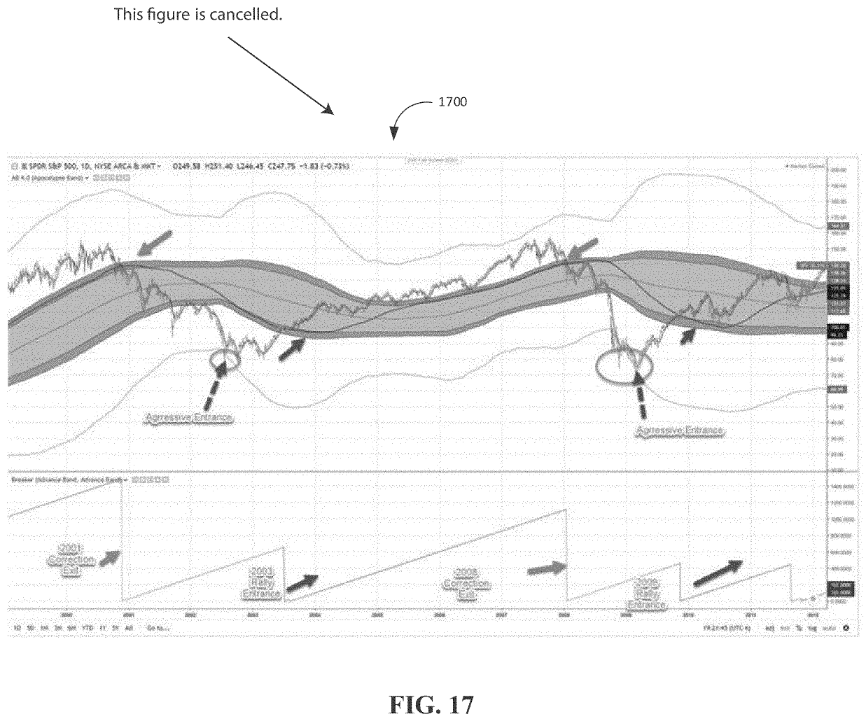

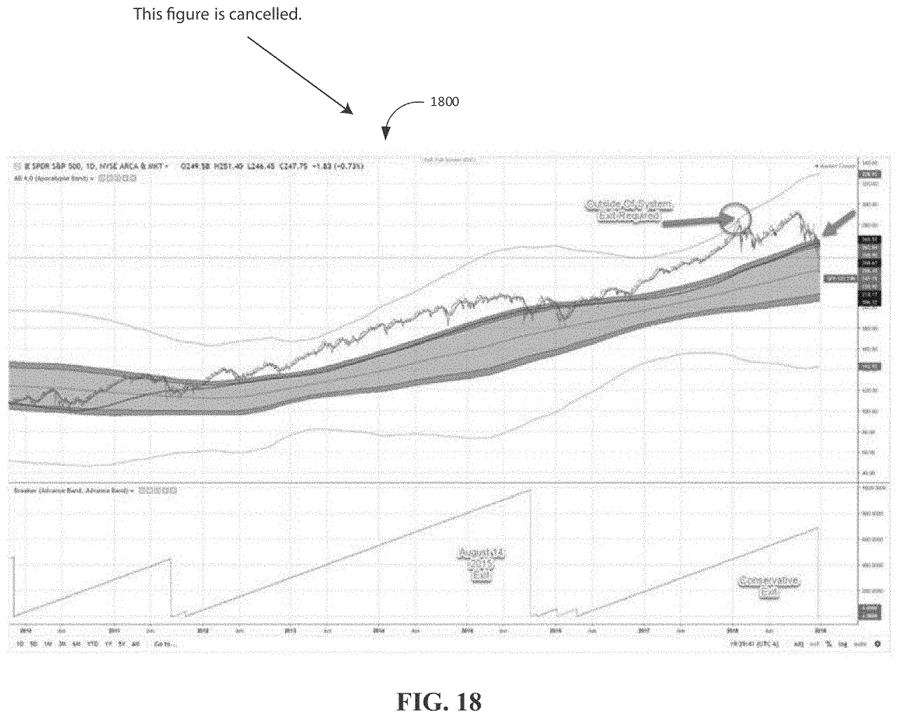

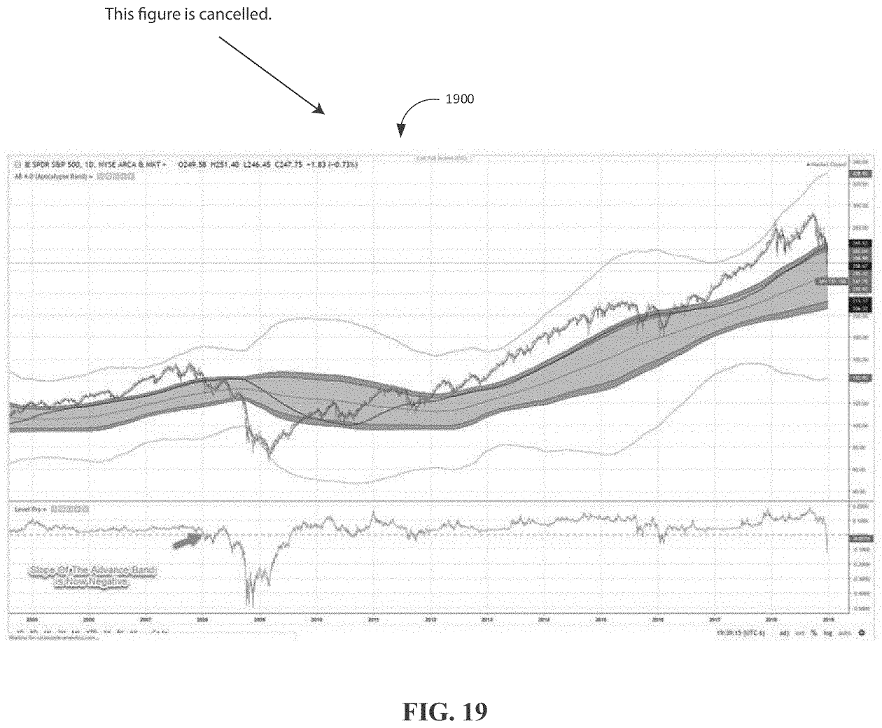

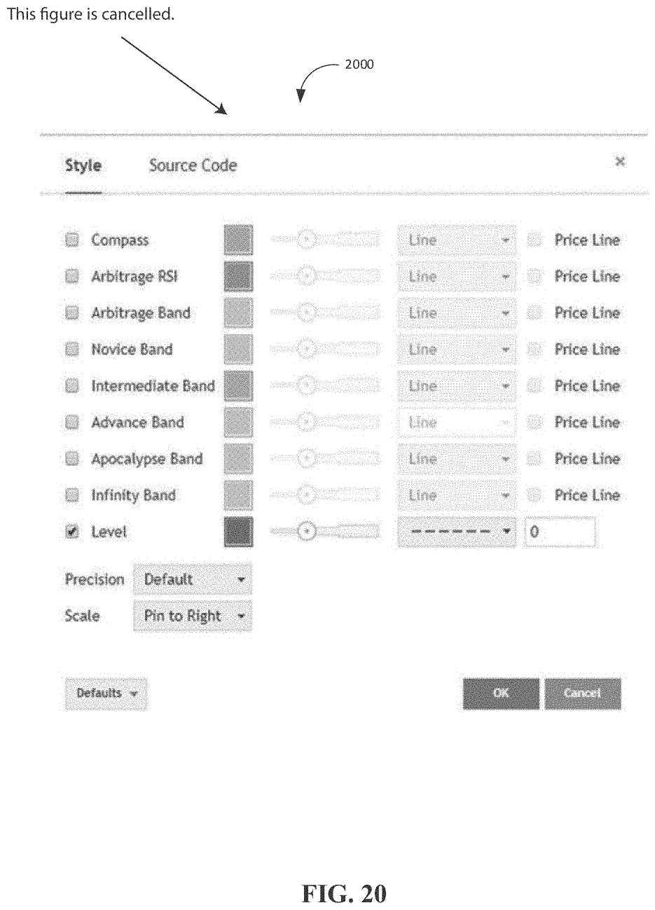

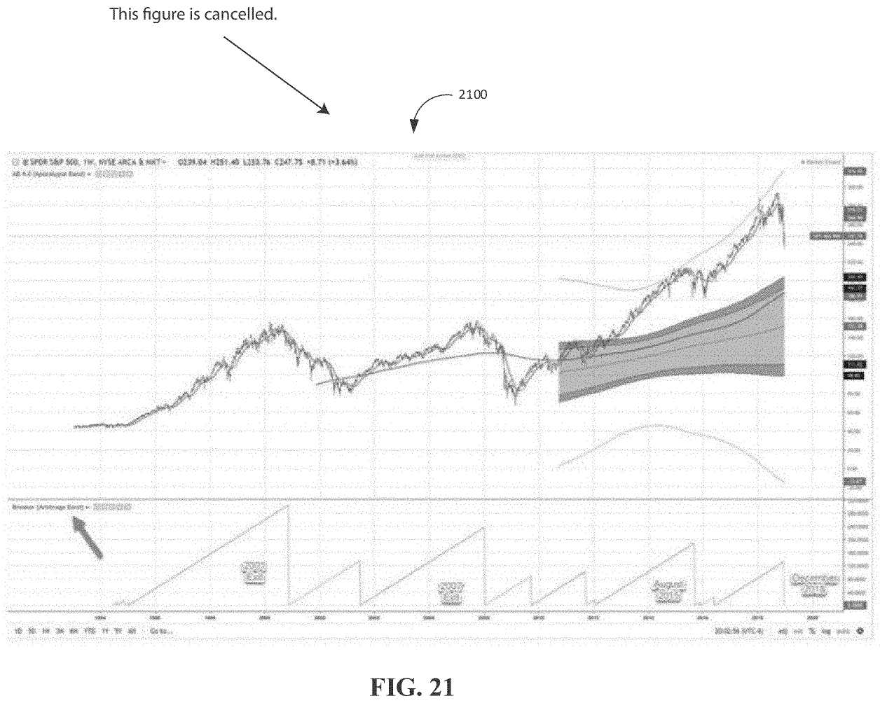

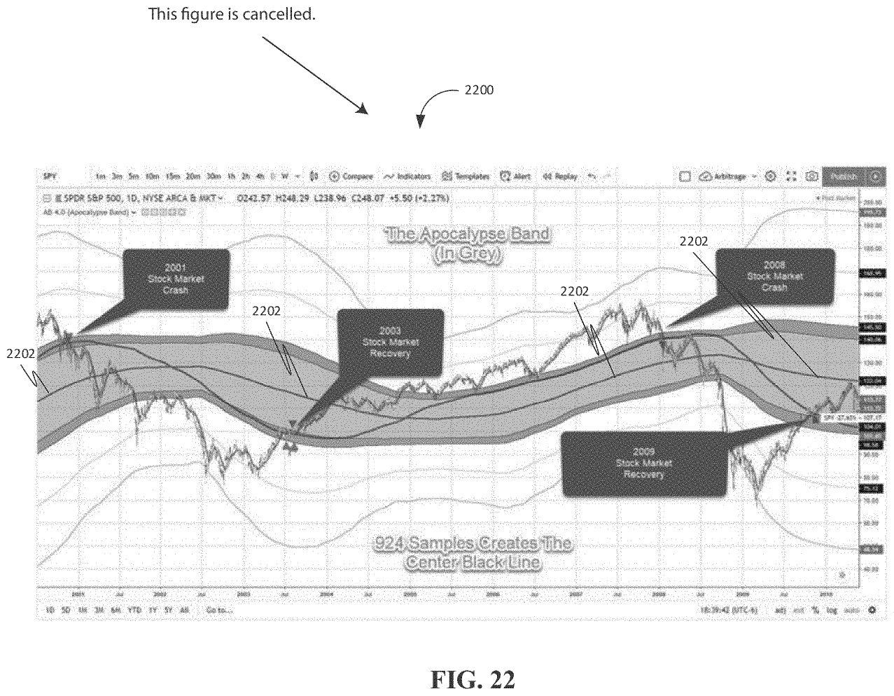

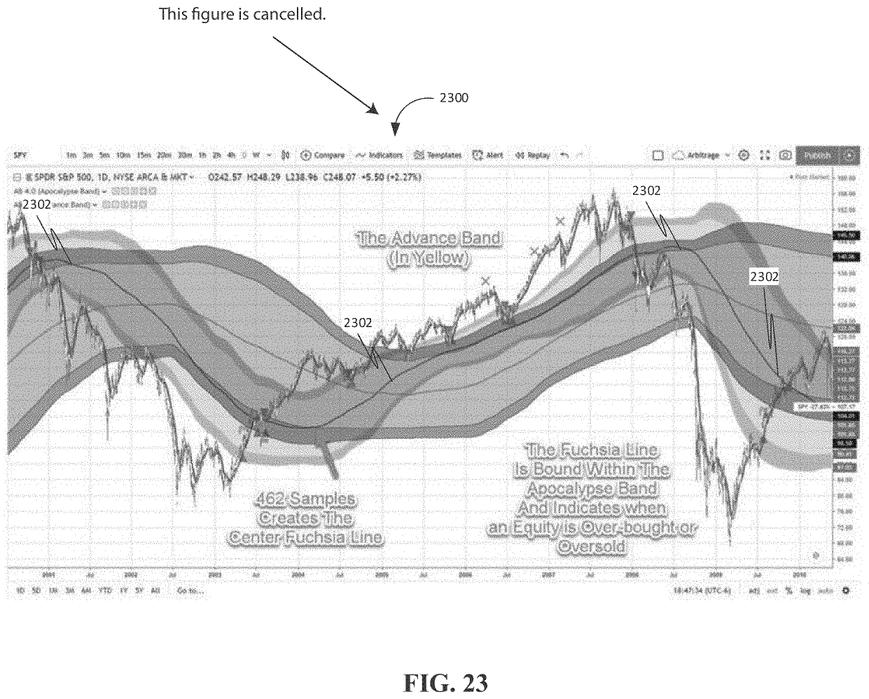

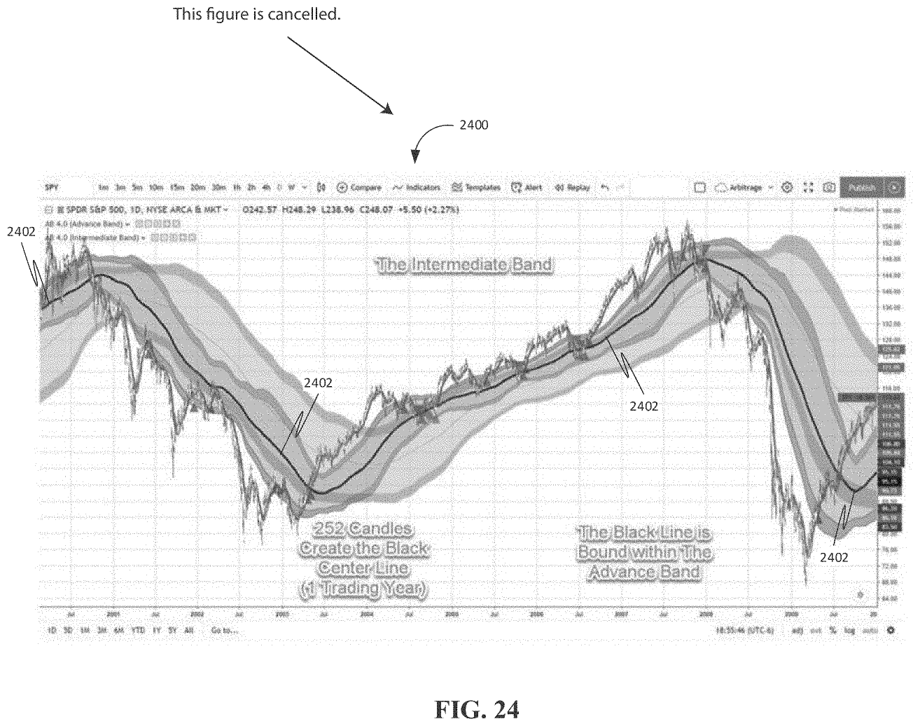

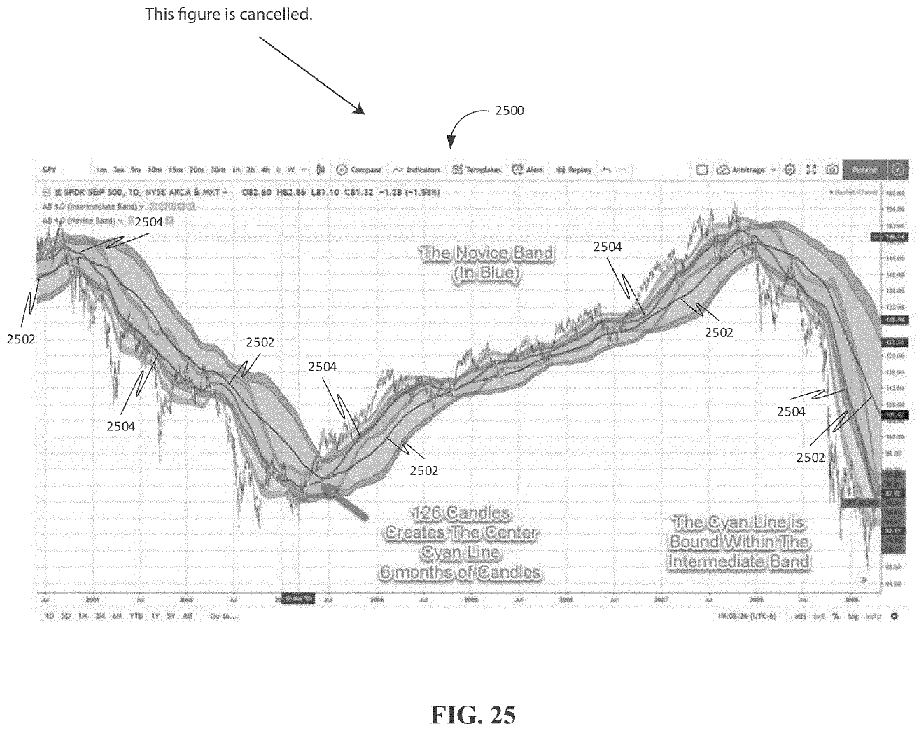

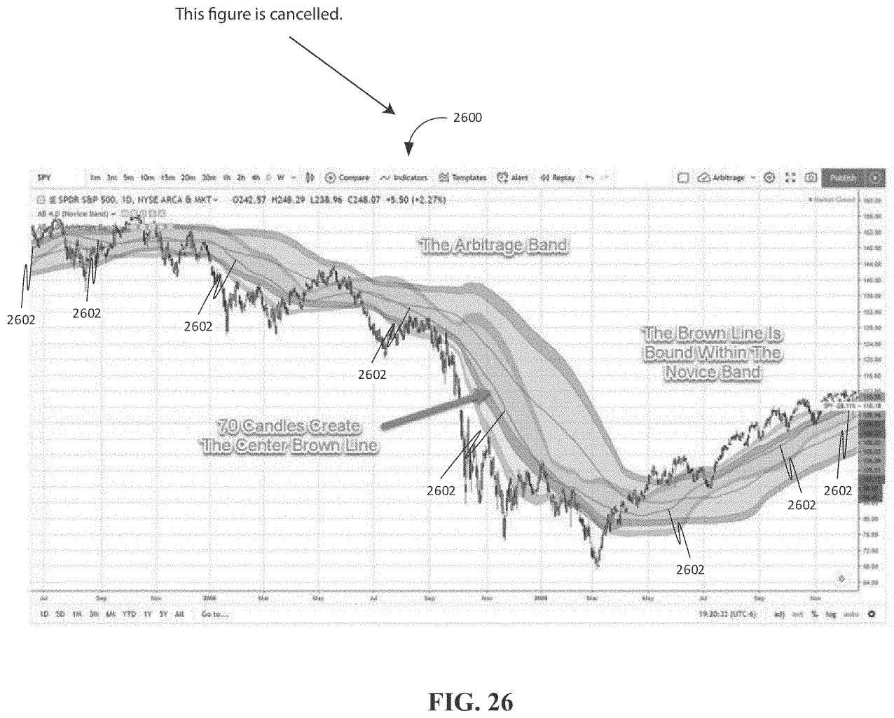

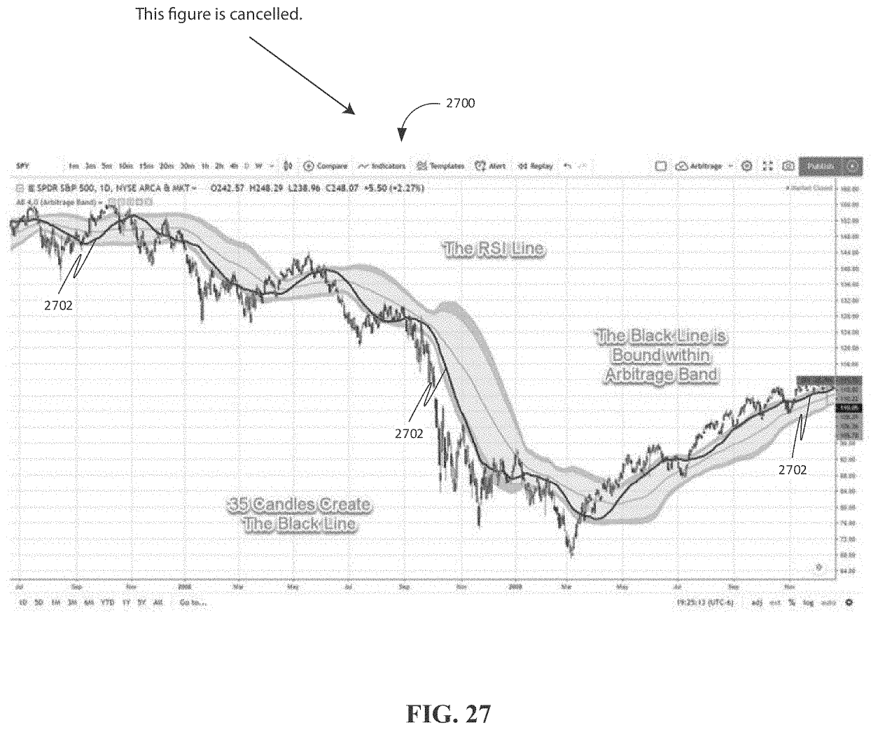

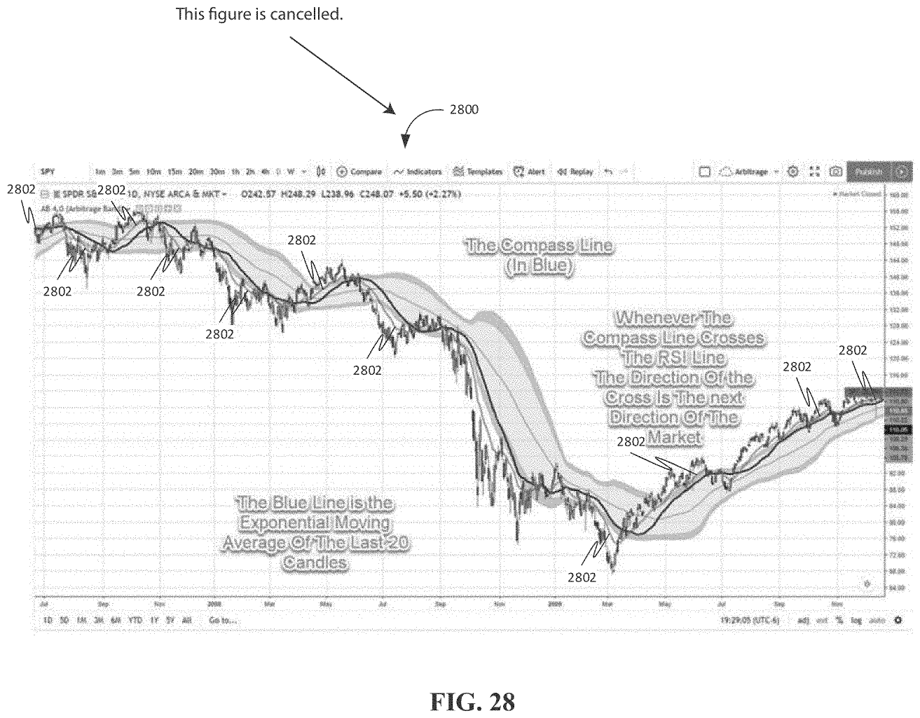

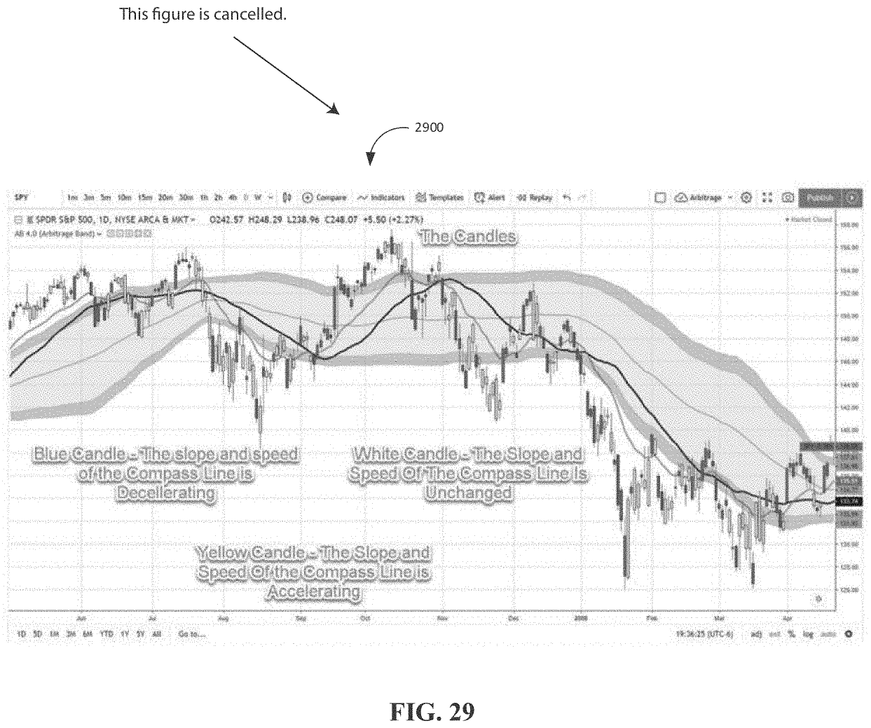

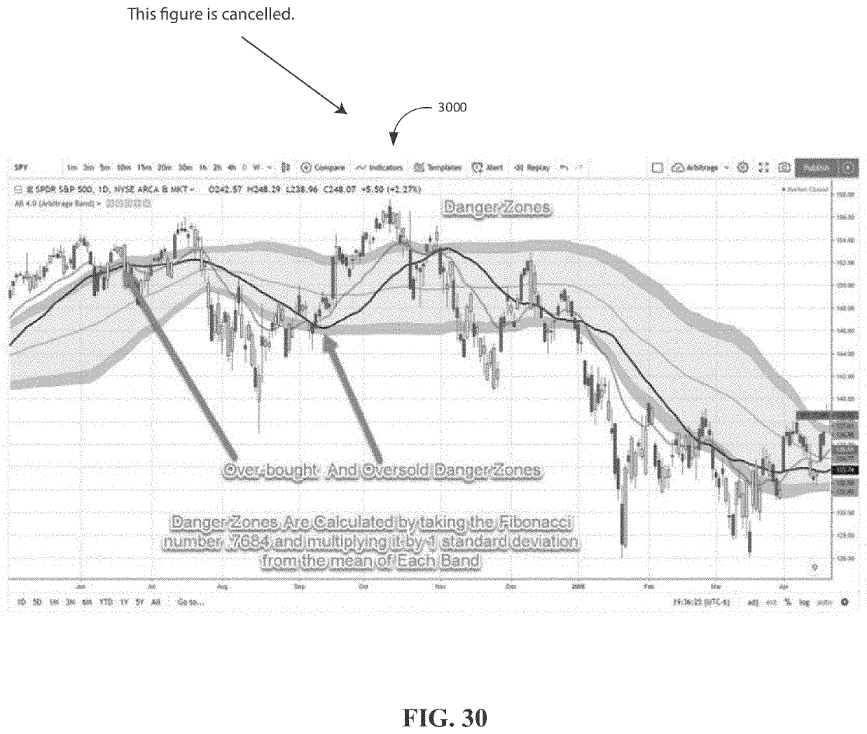

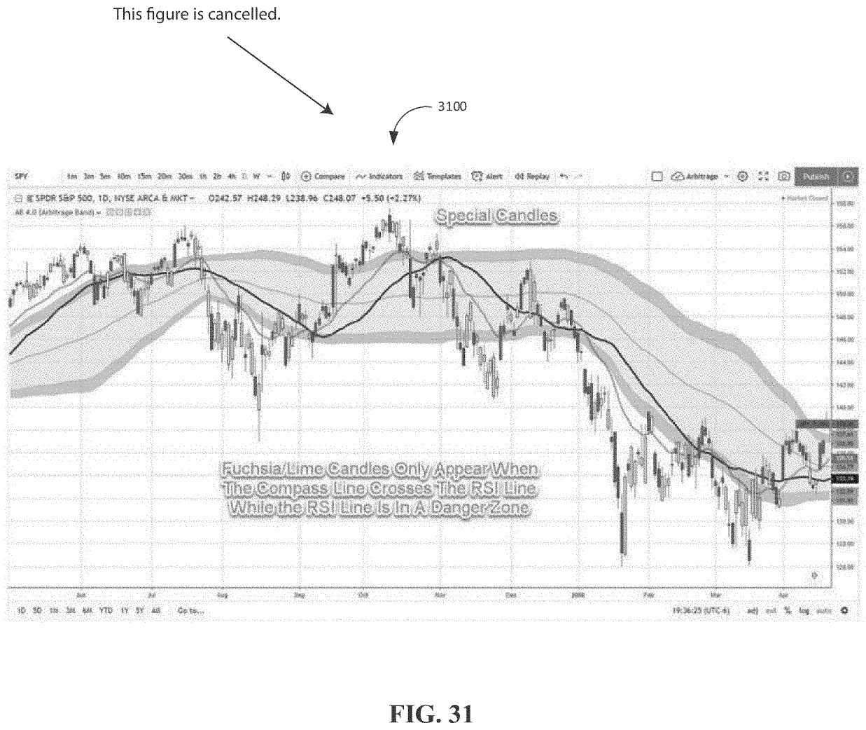

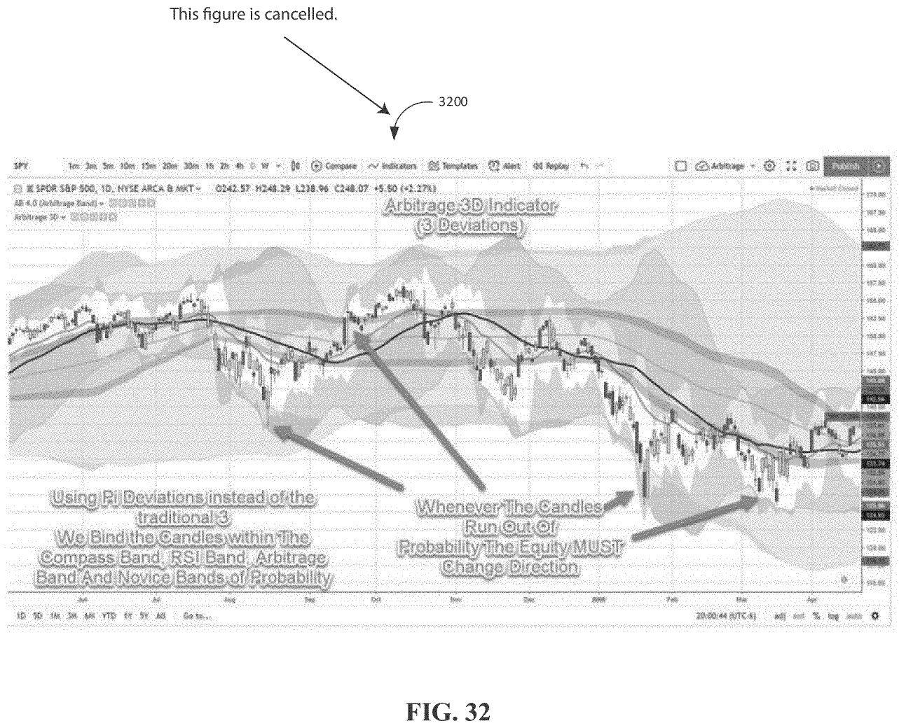

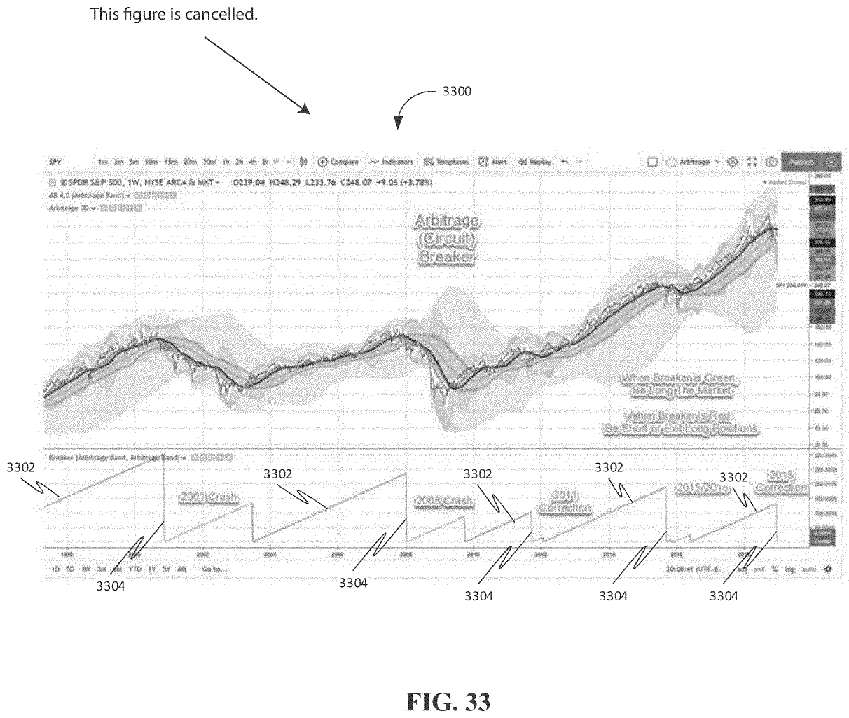

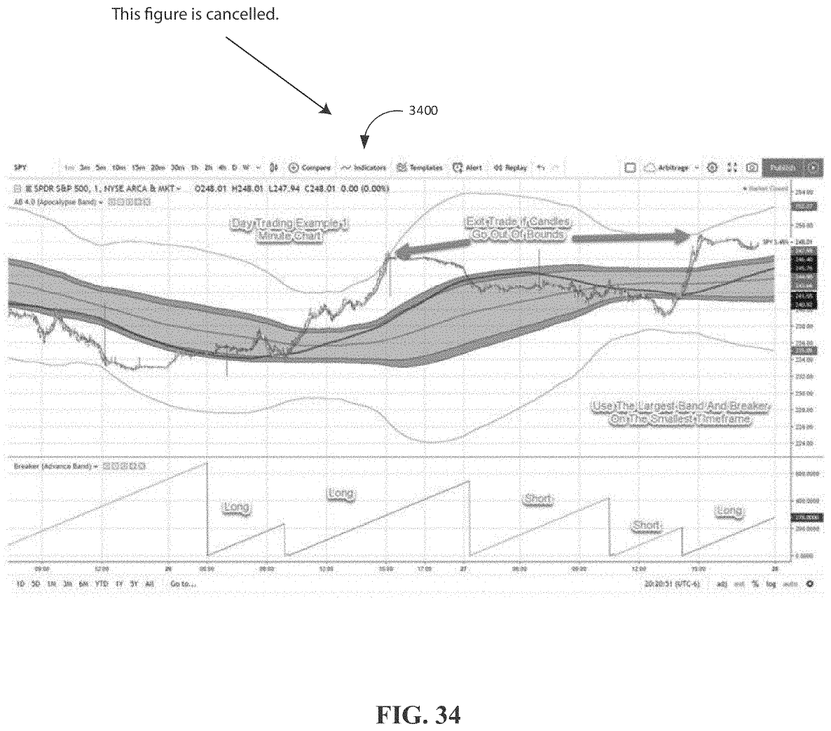

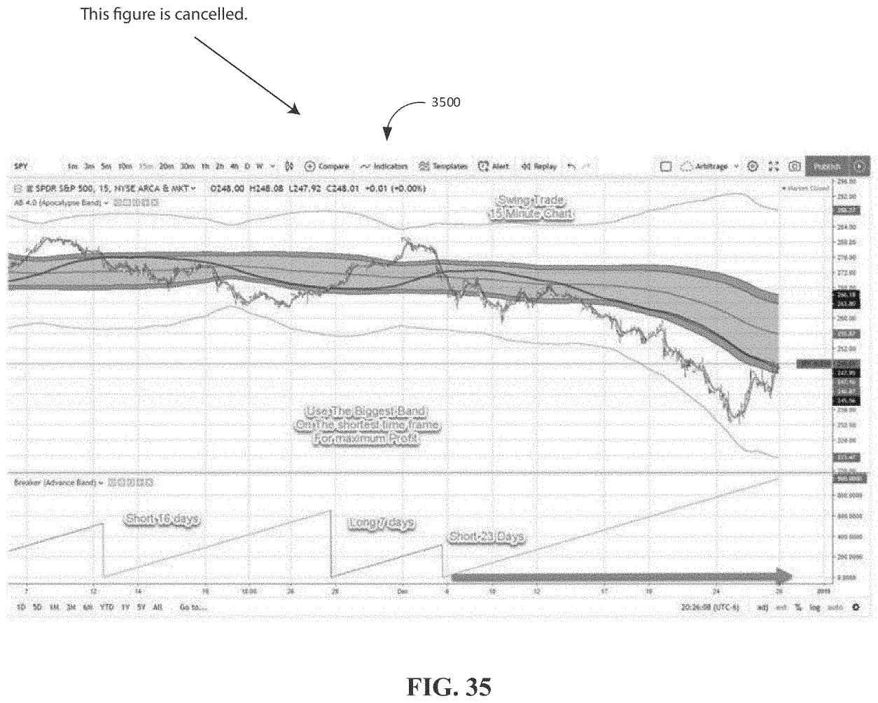

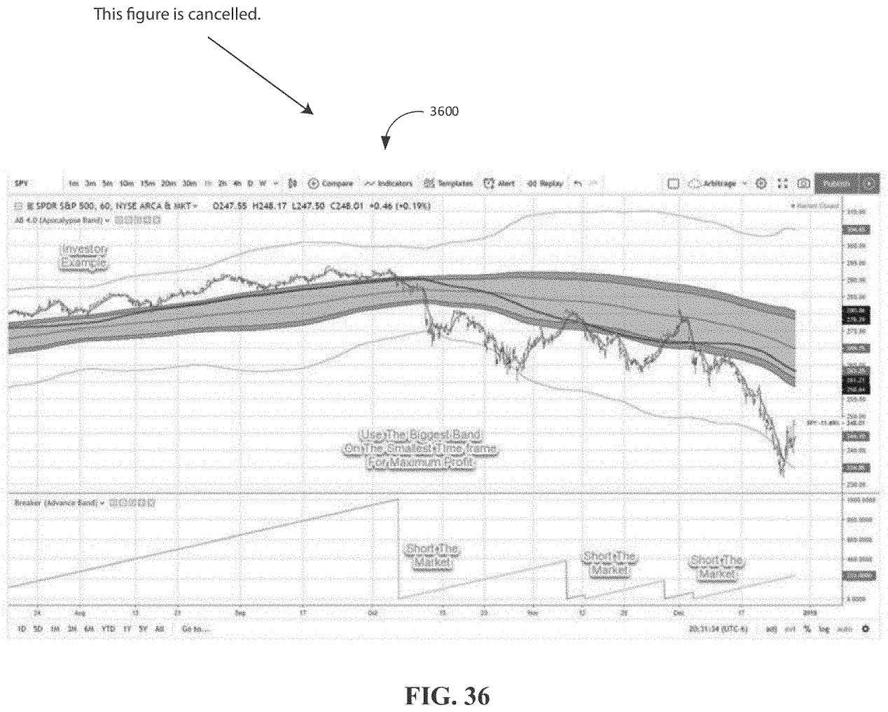

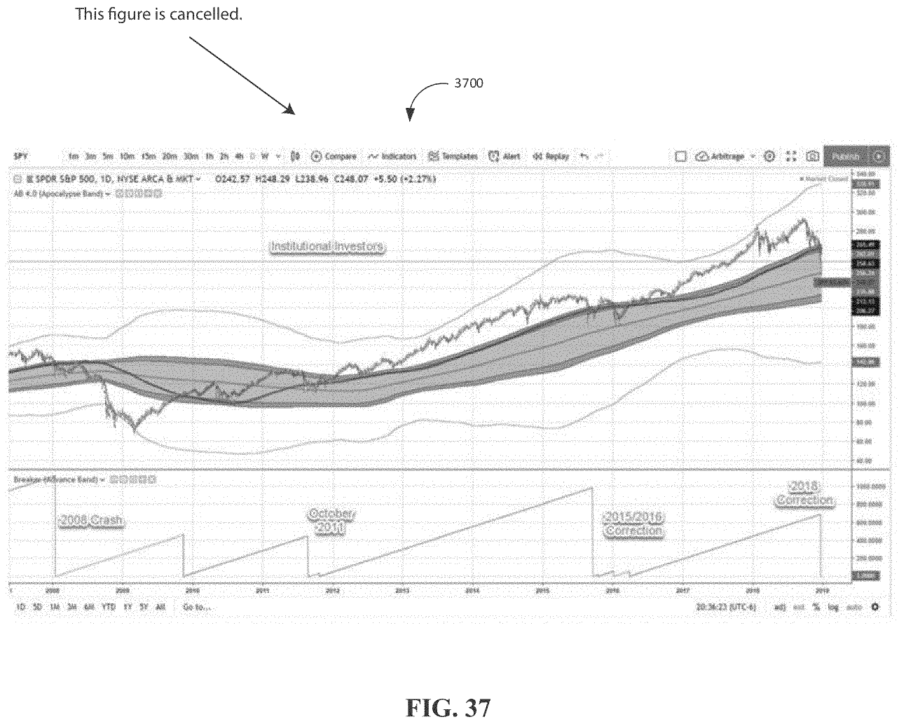

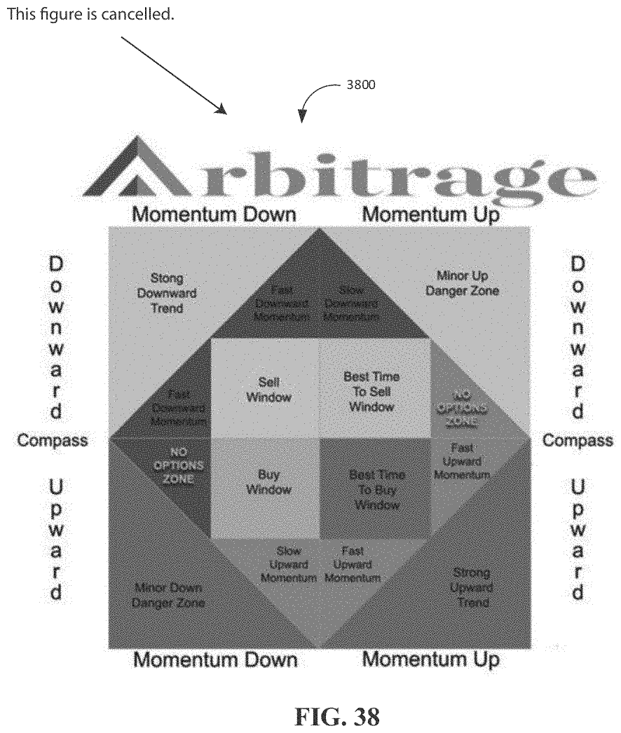

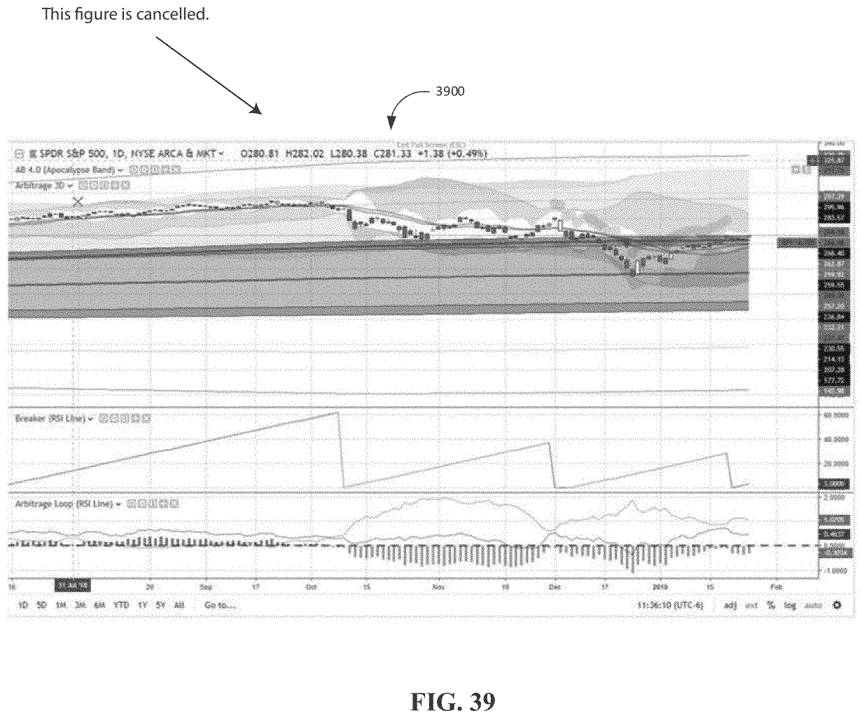

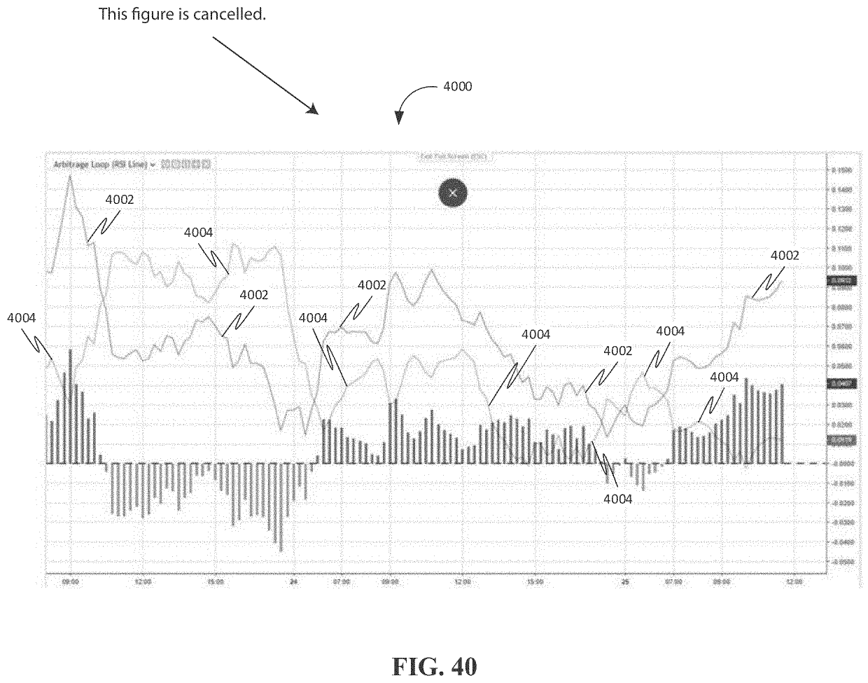

With reference to FIG. 4, a system consistent with an embodiment of the disclosure may include a computing device or cloud service, such as computing device 4100. In a basic configuration, computing device 4100 may include at least one processing unit 4102 and a system memory 4104. Depending on the configuration and type of computing device, system memory 4104 may comprise, but is not limited to, volatile (e.g. random-access memory (RAM)), non-volatile (e.g. read-only memory (ROM)), flash memory, or any combination. System memory 4104 may include operating system 4105, one or more programming modules 4106, and may include a program data 4107. Operating system 4105, for example, may be suitable for controlling computing device 4100's operation. In one embodiment, programming modules 4106 may include image-processing module, machine learning module. Furthermore, embodiments of the disclosure may be practiced in conjunction with a graphics library, other operating systems, or any other application program and is not limited to any particular application or system. This basic configuration is illustrated in FIG. 4 by those components within a dashed line 4108.

Computing device 4100 may have additional features or functionality. For example, computing device 4100 may also include additional data storage devices (removable and/or non-removable) such as, for example, magnetic disks, optical disks, or tape. Such additional storage is illustrated in FIG. 4 by a removable storage 4109 and a non-removable storage 4110. Computer storage media may include volatile and non-volatile, removable and non-removable media implemented in any method or technology for storage of information, such as computer-readable instructions, data structures, program modules, or other data. System memory 4104, removable storage 4109, and non-removable storage 4110 are all computer ti storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 4100. Any such computer storage media may be part of device 4100. Computing device 4100 may also have input device(s) 4112 such as a keyboard., a mouse, a pen, a sound. input device, a touch input device, a location sensor, a. camera, a biometric sensor, etc. Output device(s) 4114 such as a display, speakers, a printer, etc. may also be included. The aforementioned devices are examples and others may be used.

Computing device 4100 may also contain. a communication connection 4116 that may allow device 4100 to communicate with other computing devices 4118, such as over a network in a distributed computing environment, for example, an intranet or the Internet. Communication connection 4116 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and. wireless media such as acoustic, radio frequency (RF), infrared, and other wireless media. The term computer readable media as used herein may include both storage media and communication media.

As stated above, a number of program modules and data files may be stored in system memory 4104, including operating system 4105. While executing on processing unit 4102, programming modules 4106 (e.g., application 4120 such as a media player) may perform processes including, for example, one or more stages of methods, algorithms, systems, applications, servers, databases as described above. The aforementioned process is an example, and processing unit 4102 may perform other processes. Other programming modules that may be used in accordance with embodiments of the present disclosure may include machine learning applications.

Generally, consistent with embodiments of the disclosure, program modules include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based. or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Nate that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carder wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred. embodiment, it is to be understood that many other possible modifications and variations can be made without departing from the spirit and scope of the disclosure.

What is claimed is:

1. A method of modeling a financial instrument based on a physical model, wherein the method comprising:
receiving, using a communication device, at least one parameter associated with the financial instrument;
analyzing, using a processing device, the at least one parameter;
identifying, using the processing device, the physical model based on analyzing;
generating, using the processing device, the financial instrument model based on identifying and the analyzing;
receiving, using the communication device, a request from a user device;
generating, using the processing device, a response based on the request and the financial instrument model; and
transmitting, using the communication device, the response to the user device.

2. The method of claim 1, wherein the modeling comprises of determining a trajectory of the at least one parameter associated with the financial instrument.

3. The method of claim 1, wherein the physical model corresponds to at least one law governing at least one physical object.

4. The method of claim 1, wherein the physical model comprises the at least one physical object and at least one physical variable corresponding to the at least one physical object and the at least one law governing the behavior of the at least one physical object, wherein the generating of the financial instrument model comprises associating, using the processing device, the at least one parameter to at least one of the at least one physical object, the at least one physical variable and the at least one law.

5. The method of claim 4, wherein the at least one parameter comprises a plurality of data values corresponding to a property of the financial instrument, wherein the plurality of data values is associated with a plurality of physical objects comprised in the physical model, wherein at least one metric associated with the plurality of data values is associated with the at least one law.

6. The method of claim 5, wherein the plurality of data values corresponding to the property of the financial instrument is associated with the at least one law governing the behavior of the at least one physical object comprised in the physical model, wherein the at least one metric associated with the plurality of data values is associated with the at least one physical variable corresponding to the at least one physical object.

7. The method of claim 1, wherein the financial instrument model comprises one or more physical variables associated with the financial instruments, wherein the one or more physical variables is determined by using the one or more parameters associated with a plurality of input data.

8. The method of claim 7, wherein the one or more physical variables associated with the financial instruments comprise at least one of a speed, a direction, and an extreme of each of the financial instruments.

9. The method of claim 8, wherein the at least one of the speed and the direction of each of the financial instruments is determined by using ten one standard deviation bands of varying sample length based on the plurality of input data.

10. The method of claim 8, wherein the at least one of the extremes associated with the financial instruments is determined by using ten Pi standard deviation band of varying sample length based on the plurality of input data.

11. A system to facilitate modeling a financial instrument based on a physical model, wherein the system comprising:
a communication device configured for receiving at least one parameter associated with the financial instrument, receiving a request from a user device, and transmitting a response to the user device;
a processing device configured for analyzing the at least one parameter, identifying the physical model based on analyzing, generating the financial instrument model based on the identifying and analyzing, and generating the respond based on the request and the financial instrument model.

12. The system of claim 11, wherein the modeling comprises of determining a trajectory of the at least one parameter associated with the financial instrument.

13. The system of claim 11, wherein the physical model corresponds to at least one law governing at least one physical object.

14. The system of claim 11, wherein the physical model comprises the at least one physical object and at least one physical variable corresponding to the at least one physical object and the at least one law governing the behavior of the at least one physical object, wherein the generating of the financial instrument model comprises associating, using the processing device, the at least one parameter to at least one of the at least one physical object, the at least one physical variable and the at least one law.

15. The system of claim 14, wherein the at least one parameter comprises a plurality of data values corresponding to a property of the financial instrument, wherein the plurality of data values is associated with a plurality of physical objects comprised in the physical model, wherein at least one metric associated with the plurality of data values is associated with the at least one law.

16. The system of claim 15, wherein the plurality of data values corresponding to the property of the financial instrument is associated with the at least one law governing the behavior of the at least one physical object comprised in the physical model, wherein the at least one metric associated with the plurality of data values is associated with the at least one physical variable corresponding to the at least one physical object.

17. The system of claim 11, wherein the financial instrument model comprises one or more physical variables associated with the financial instruments, wherein the one or more physical variables is determined by using the one or more parameters associated with a plurality of input data.

18. The system of claim 17, wherein the one or more physical variables associated with the financial instruments comprise at least one of a speed, a direction, and an extreme of each of the financial instruments.

19. The system of claim 18, wherein the at least one of the speed and the direction of each of the financial instruments is determined by using ten one standard deviation bands of varying sample length based on the plurality of input data.

20. The system of claim 18, wherein the at least one of the extremes associated with the financial instruments is determined by using ten Pi standard deviation band of varying sample length based on the plurality of input data.
